(19) United States
(12) Patent Application Publication
(10) Pub. No.: US 2004/0267592 A1
(43) Pub. Date: Dec. 30, 2004

(54) Method and program for assisting a worker in charge of operations

(76) Inventors: Shoji Ogushi, Nagano-ken (JP); Masanori Kojima, Nagano-ken (JP)

Correspondence Address: SHERIDAN ROSS PC, 1560 BROADWAY, SUITE 1200, DENVER, CO, 80202

(21) Appl. No.: 10/684,219

(22) Filed: Oct. 10, 2003

(30) Foreign Application Priority Data
Oct. 11, 2002 (JP) 2002-299353
Oct. 6, 2003 (JP) 2003-347043

(51) Int. Cl. G06F 17/60

(52) U.S. Cl. 705/9

(57) ABSTRACT

A management server extracts information on an unaccepted work request from another work area other than the work area of a worker from a reception information memory section and detailed reception information memory section. The management server computes a relative distance between the worker and a client from the longitude and latitude of the terminal of the worker and the longitude and latitude of the client, and extracts information showing that the relative distance lies within a predetermined distance from the extracted information on the unaccepted work request. Further, the management server extracts information needed for a work item from the information showing the relative distance lying within the predetermined distance and sends that information to the worker's terminal. The worker selects work request items from a work request list and sends them to the management server. The management server updates a progress code, etc. corresponding to the selected items.

### BACKGROUND OF THE INVENTION

The present invention relates to a method for assisting a worker and a program for assisting a worker.

In the case where work items are carried out according to requests from clients, conventionally, the requests are classified into individual work categories and are assigned to workers in charge of the work categories. In principle, a worker in charge copes with a request from a client in an associated work category. Such a method was adapted to, for example, maintenance service for equipment located at the place of a client. A work area was assigned to a worker who would go to a work place where equipment was located in accordance with a maintenance request from a client. The worker would perform work according to a work schedule in his or her work area and would receive an instruction from a work supervisor at a management center in the case where a new work request came in (see Japanese Laid-Open patent publication No. 2002-169938, for example).

The conventional method has a problem such that some work areas receive a lot of work requests while some other work areas have fewer work requests, so that work items cannot be performed efficiently as a whole. As one way to cope with the difference between the number of work items in one work area and the number of work items in another work area, a work manager or the like may organize the work items. This however puts a burden on the work manager.

### SUMMARY OF THE INVENTION

Accordingly, it is an object of the present invention to provide a worker assisting method and a worker assisting program for assigning a request outside a work category or a work area to a worker.

To achieve the object, the present invention provides a method of using a computer system. The computer system has at least a first memory device for storing reception information on goods or service requests and a second memory device for storing worker information on the worker. The method is used to assist a worker who takes charge of a predetermined work category by providing the worker with information of a work item outside the work category. The method includes the step of extracting reception information about a request outside the work category of the worker and in an unaccepted state from the reception information stored in the first memory device based on the worker information, the step of extracting reception information about a request which can be handled by the worker from the reception information, extracted based on the worker information, based on a predetermined condition, the step of sending the reception information extracted based on the predetermined condition to a terminal possessed by the worker, and the step of, upon reception of notification that the reception information sent to the terminal has been selected by the worker, updating the selected reception information to an accepted state from an unaccepted state.

The present invention also provides another method of using a computer system. The method is used to assist a worker who takes charge of a predetermined work area and travels to and works at a work place by providing the worker with information of a work item outside the work area. The method includes the step of storing in a memory device work reception information which is information on a received work request from a client and which includes information about a work place indicating a place of the received work request and work request information that is needed when fulfilling the received work request, the step of extracting work reception information outside the work area of the worker and in an unaccepted state from the work reception information stored in the memory device, the step of computing a relative distance between the work place included in the extracted work reception information, the location of the worker and the work place, the step of extracting work reception information showing that the relative distance lies within a predetermined distance from the extracted work reception information, the step of extracting work request information included in the extracted work reception information and sending that work request information to a terminal possessed by the worker, and the step of, when the reception information sent to the terminal is selected by the worker, updating the selected work reception information to an accepted state from an unaccepted state.

The present invention further provides another method of using a computer system. The method is used to assist a worker who takes charge of a predetermined work area and travels to and works at a work place by providing the worker with information of a work item outside the work area. The method includes the step of storing in a memory device work reception information which is information on an accepted work request from a client and which includes work request information that is needed when fulfilling the received work request, the step of extracting work reception information outside the work area of the worker and in an unaccepted state from the work reception information stored in the memory device, the step of extracting work reception information showing that a work target is a type of a machine assigned to the worker from the extracted work reception information, the step of extracting work request information included in the extracted work reception information and sending that work request information to a terminal possessed by the worker, and the step of, when the reception information sent to the terminal is selected by the worker, updating the selected work request information to an accepted state from an unaccepted state.

The present invention also provides another method of using a computer system. The method is used to assist a worker who takes charge of a predetermined work area and travels to and works at a work place by providing the worker with information of a work item outside the work area. The method includes the step of storing in a memory device work reception information which is information on an accepted work request from a client and which includes work request information that is needed when fulfilling the accepted work request, the step of extracting work reception information outside the work area of the worker and in an unaccepted state from the work reception information stored in the memory device, the step of extracting work reception information showing that a required skill for a work item is equal to or less than the skill of the worker from the extracted work reception information, the step of extracting work request information included in the extracted work reception information and sending that work request information to a terminal possessed by the worker, and the step of, when the reception information sent to the terminal is selected by the worker, updating the selected work request information to an accepted state from an unaccepted state.

The present invention further provides another method of using a computer system. The method is used to assist a worker who takes charge of a predetermined work area and travels to and works at a work place by providing the worker with information of a work item outside the work area. The method includes the step of storing in a memory device work reception information which is information on an accepted work request from a client and which includes information about a work place indicating a place of the accepted work request and work request information that is needed when fulfilling the accepted work request, the step of extracting work reception information outside the work area of the worker and in an unaccepted state from the work reception information stored in the memory device, the step of computing a travel time from a location of the worker to the work place, the step of extracting work reception information showing that the travel time lies within a predetermined time from the extracted work reception information, the step of extracting work request information included in the extracted work reception information and sending that work request information to a terminal possessed by the worker, and the step of, when the reception information sent to the terminal is selected by the worker, updating the selected work request information to an accepted state from an unaccepted state.

The present invention further provides a computer recording medium on which a computer program instruction is recorded. The computer recording medium is used to assist a worker who takes charge of a predetermined work category by providing the worker with information of a work item outside the work category. The computer program instructions are executed by a computer system. The computer program instructions have a plurality of steps which are executed by the computer system. The computer system has at least a first memory device for storing reception information on goods or service requests and a second memory device for storing worker information on the worker. The computer program instructions include extraction of reception information about a request outside the work category of the worker and in an unaccepted state from the reception information stored in the first memory device based on the worker information, extraction of reception information about a request which can be handled by the worker from the reception information, extracted based on the worker information, based on a predetermined condition, transmission of the reception information extracted based on the predetermined condition to a terminal possessed by the worker, and, upon reception of notification that the reception information sent to the terminal has been selected by the worker, updating of, the selected reception information to an accepted state from an unaccepted state.

The present invention further provides a computer recording medium on which computer program instructions are recorded. The computer recording medium is used to assist a worker who takes charge of a predetermined work category by providing the worker with information of a work item outside the work category. The computer program instructions are executed by a computer system. The computer program instructions have a plurality of steps which are executed by the computer system. The computer program instructions includes storing, in a memory device, work reception information which is information on a received work request from a client and which includes information about a work place indicating a place of the received work request and work request information that is needed when fulfilling the received work request, extraction of work reception information outside the work area of the worker and in an unaccepted state from the work reception information stored in the memory device, computation of a relative distance between the work place included in the extracted work reception information and the location of the worker, extraction of work reception information showing that the relative distance lies within a predetermined distance from the extracted work reception information, extraction of work request information included in the extracted work reception information and transmission of that work request information to a terminal possessed by the worker, and, when the reception information sent to the terminal is selected by the worker, updating of the selected work request information to an accepted state from an unaccepted state.

The present invention further provides a computer recording medium on which computer program instructions are recorded. The computer recording medium is used to assist a worker who takes charge of a predetermined work category by providing the worker with information of a work item outside the work category. The computer program instructions re executed by a computer system. The computer program instructions have a plurality of steps which are executed by the computer system. The computer program instructions includes storing, in a memory device, work reception information which is information on an accepted work request from a client and which includes information about a work place indicating a place of the accepted work request and work request information that is needed when fulfilling the accepted work request, extraction of work reception information outside the work area of the worker and in an unaccepted state from the work reception information stored-in the memory device, extraction of work reception information showing that a work target is a type of a machine assigned to the worker from the extracted work reception information, extraction of work request information included in the extracted work reception information and transmission of that work request information to a terminal possessed by the worker, and, when the reception information sent to the terminal is selected by the worker, updating of the selected work request information to an accepted state from an unaccepted state.

The present invention further provides a computer recording medium on which computer program instructions are recorded. The computer recording medium is used to assist a worker who takes charge of a predetermined work category by providing the worker with information of a work item outside the work category. The computer program instructions are executed by a computer system. The computer program instructions have a plurality of steps which are executed by the computer system. The computer program instructions includes storing, in a memory device, work reception information which is information on an accepted work request from a client and which includes work request information that is needed when fulfilling the accepted work request, extraction of work reception information outside the work area of the worker and in an unaccepted state from the work reception information stored in the memory device, extraction of work reception information showing that a required skill for a work is equal to or less than a skill of the worker from the extracted work reception information, extraction of work request information included in the extracted work reception information and transmission of that work request information to a terminal possessed by the worker, and, when the reception information sent to the terminal is selected by the worker, updating of the selected work request information to an accepted state from an unaccepted state.

The present invention further provides a computer recording medium on which computer program instructions are recorded. The computer recording medium is used to assist a worker who takes charge of a predetermined work category by providing the worker with information of a work item outside the work category. The computer program instructions re executed by a computer system. The computer program instructions have a plurality of steps which are executed by the computer system. The computer program instructions include storing, in a memory device, work reception information which is information on an accepted work request from a client and which includes information about a work place indicating a place of the accepted work request and work request information that is needed when fulfilling the accepted work request, extraction of work reception information outside the work area of the worker and in an unaccepted state from the work reception information stored in the memory device, computing a travel time from a location of the worker to the work place, extraction of work reception information showing that the travel time lies within a predetermined time from the extracted work reception information, extraction of work request information included in the extracted work reception information and transmission of that work request information to a terminal possessed by the worker, and, when the reception information sent to the terminal is selected by the worker, updating of the selected work request information to an accepted state from an unaccepted state.

Other modes and advantages of the present invention will be readily apparent from the following description together with the accompanying drawings which show an example of the principles of the present invention.

### BRIEF DESCRIPTION OF THE DRAWINGS

The features of the present invention that are believed to be novel are set forth with particularity in the appended claims. The present invention, together with objects and advantages thereof, may best be understood by reference to the following description of the presently preferred embodiments together with the accompanying drawings.

FIG. 1 is a schematic diagram of a system according to a first embodiment;

FIG. 2 is an explanatory diagram of data stored in individual memory sections;

FIG. 3 is an explanatory diagram of a display screen of a service department terminal;

FIG. 4 is an explanatory diagram of a display screen of the service department terminal;

FIG. 5 is an explanatory diagram of a display screen of the service department terminal;

FIG. 6 is an explanatory diagram of a display screen of the terminal of a worker;

FIG. 7 is an explanatory diagram of a display screen of the worker terminal;

FIG. 8 is an explanatory diagram of a display screen of the worker terminal;

FIG. 9 is an explanatory diagram of procedures of the first embodiment;

FIG. 10 is an explanatory diagram of procedures of the first embodiment;

FIG. 11 is an explanatory diagram of procedures of the first embodiment;

FIG. 12 is an explanatory diagram of procedures of the first embodiment;

FIG. 13 is an explanatory diagram of procedures of the first embodiment;

FIG. 14 is an explanatory diagram of procedures of a second embodiment; and

FIG. 15 is an explanatory diagram of procedures of the third embodiment.

### DETAILED DESCRIPTION OF THE PREFERRED EMBODIMENTS

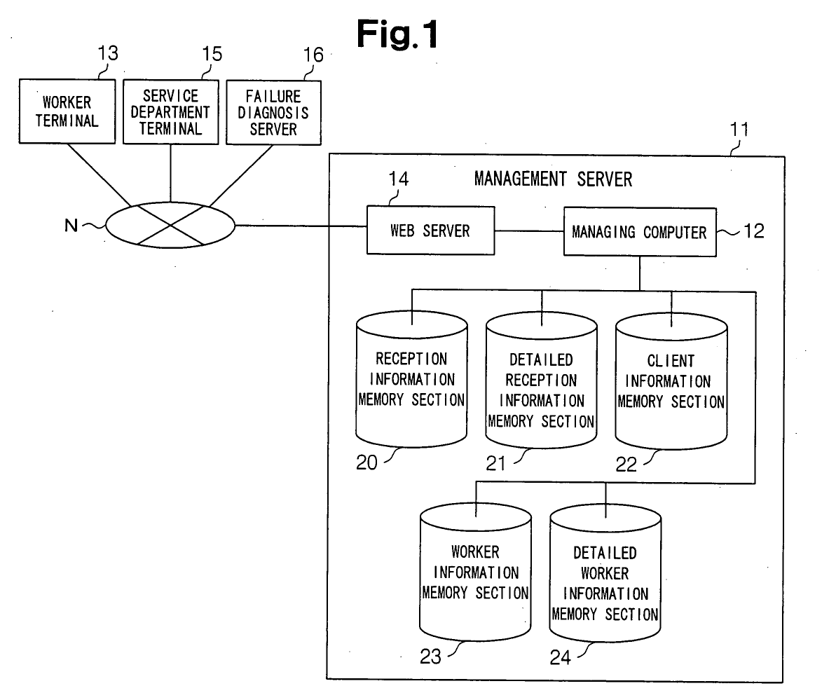

The first embodiment of a worker assisting system embodying the present invention will be described below referring to FIGS. 1 to 13. The following description of the embodiment will be given of a system which allows a worker who performs work, such as repairing, maintenance and so forth of machines in the worker's work area (work category) to accept a work item outside the work area using the worker's own terminal in the case where a work item in the worker's work area is complete or in the case where the worker receives an instruction from a management center.

FIG. 1 is a schematic diagram of a worker assisting system according to the first embodiment. A management server 11 is located in the management center at which work requests from clients are received. The management server 11 includes a managing computer 12. The managing computer 12 comprises an unillustrated CPU, RAM and so forth and performs data reading and writing with respect to memory sections 20 to 24, runs a worker assisting program and performs data processing.

The management server 11 is connected to a worker terminal 13 over a network N. The worker terminal 13 is a portable telephone terminal used by a worker and has a GPS (Global Positioning System) function. This function provides the approximate location of the worker in terms of the longitude and latitude via position detecting means, such as GPS satellites (not shown) or the like. The management server 11 has the capability to function as a web server 14. Installed in the web server 14 is software for contents which are displayed on the worker terminal 13 as a terminal carried by the worker. When the worker terminal 13 accesses the web server 14, data from a screen is transmitted to the web server 14 and the screen for assisting the worker is displayed on the worker terminal 13. The software for display of the content has data from various screens, a display program, etc. stored therein.

The management server 11 is connected to a service department terminal 15 and a failure diagnosis server 16 over the network N. The service department terminal 15 is located in the management center and used by a person performing reception (hereinafter called a “receptionist”) or a work supervisor (manager). The service department terminal 15 displays a screen for entry of received work request information from a client, sends the received work request information to the management server 11 and displays information on the cause of a failure, how to handle the failure, etc. with respect to the work request, received from the failure diagnosis server 16, on the display section. The failure diagnosis server 16 has a memory section where failure information on the cause of a failure and how to handle the failure corresponding to the failure are stored, and a program for diagnosing the cause of a failure and how to handle the failure. The failure diagnosis server 16 determines the cause of a failure and how to handle the failure from information from the failure status of a machine and sends information on the cause of a failure, how to handle the failure, required parts, etc. to the service department terminal 15. The management server 11, the worker terminal 13, the service department terminal 15 and the failure diagnosis server 16 constitute a computer system.

The management server 11 has a reception information memory section 20, a detailed reception information memory section 21, a client information memory section 22, a worker information memory section 23 and a detailed worker information memory section 24.

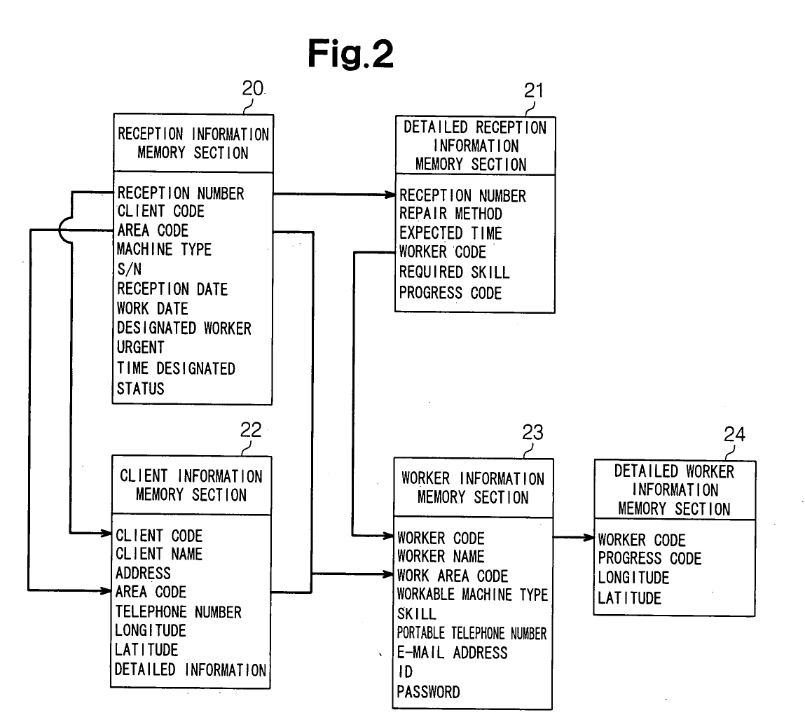

The data structures of the individual memory sections will be discussed next referring to FIG. 2.

The reception information memory section 20 stores reception information as work reception information, which is input at the time a work request from a client is received, for each reception number. The reception information includes information on a reception number, a client code, an area code, a machine type, a serial number (S/N), a reception date, a work date, a designated worker, whether a work item is urgent or not, a time designated and the state of a problem on the machine. The area code is an identifier for an area corresponding to a work place or the place of a client. The work date indicates a scheduled date for the work item. The scheduled work date is decided by the work manager. This reception information has the reception number as an identifier.

The detailed reception information memory section 21 stores information received from the failure diagnosis server 16, the worker terminal 13 or the like for each reception number. The detailed reception information includes a reception number, a repair method, an expected time, a worker code as an identifier for a worker who takes charge of a work item, a required skill as to information on the skill needed for the work item and a progress code. The repair method, the expected time and the required skill are information which has been discriminated and sent by the failure diagnosis server 16 based on a work request received from a client. The repair method is a procedure for a work item with respect to the work request and the expected time is the estimated time required for the work item. The required skill is numerical information indicating the degree of difficulty of the work item. The progress code as a progress identifier is an identifier indicating the progress of a work item performed by the worker and is updated by a command sent from the worker terminal 13; for example, “00” is set as unaccepted, “01” is set as accepted and “02” is set as the completion of a work item. The detailed reception information has the reception number as an identifier and the reception number corresponds to the reception number of reception information.

Information about clients is stored in the client information memory section 22 client by a client. This information is stored when a machine is located at the place of a client or a maintenance management contract with a client is closed, and has already been stored before a repair request is received. In the case where there is a change in client information, the client information is updated each time a change is made. The client information includes detailed information on a client code, a client name, an address, an area code, a telephone number, a longitude, a latitude, a contact state and so forth. The area code is an identifier for an area which covers the address of the client. The longitude and latitude correspond to the address of the client. The client code is used as an identifier for client information and corresponds to the client code in the reception information.

Information about workers is stored in the worker information memory section 23 worker-by-worker. The worker information includes a worker code, a worker name, a work area code, a machine type assigned, a skill, the portable telephone number of the worker terminal 13, an e-mail address of the worker terminal 13, and an ID and password needed at the time of accessing the management server 11. The work area code is an identifier for the area of which the worker is in charge and corresponds to the area code in the client information memory section 22. The assigned machine type is information on the machine types the worker can handle. The skill is numerical information indicating the degree of difficulty of a work item with which the worker can cope and corresponds to the required skill in the detailed reception information. The ID and password are assigned to each worker. The worker code is used as an identifier for worker information.

The detailed worker information memory section 24 stores information received from the worker terminal 13 as worker information. The detailed worker information includes a worker code, a progress code, a longitude and a latitude. The worker code is used as an identifier for detailed worker information and corresponds to the worker code in worker information. The progress code is an identifier indicating the progress state of a work item and corresponds to the progress code in the detailed reception information memory section 21.

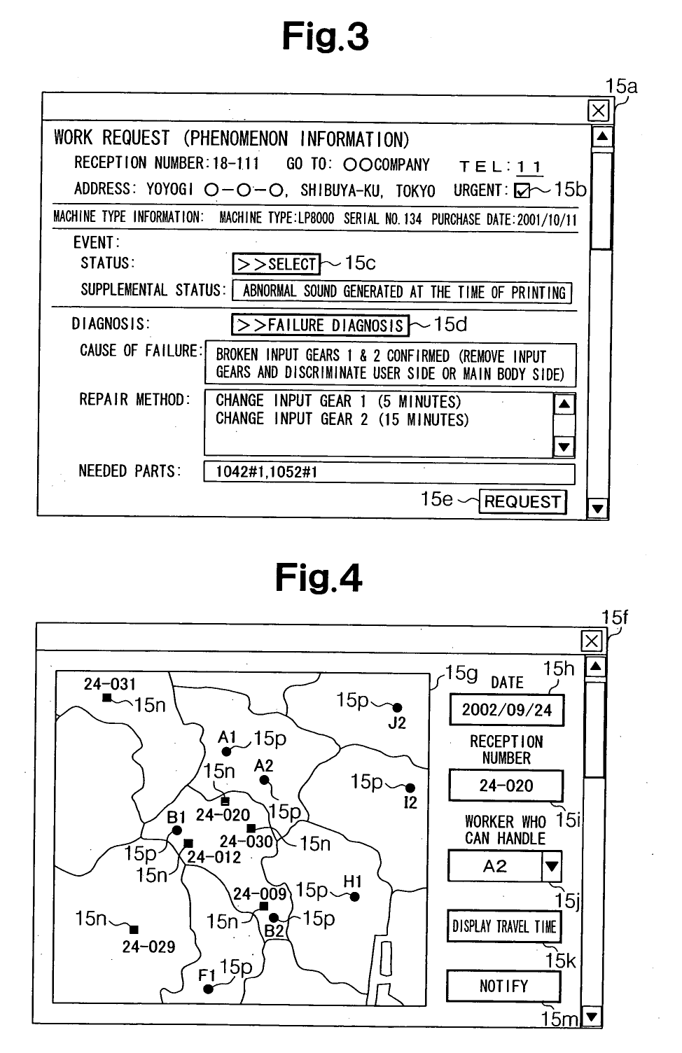

The following will discuss a work request screen 15a which is displayed on the display section of the service department terminal 15 referring to FIG. 3. The work request screen 15a displays information obtained when a failure status of a machine reported by a client code is diagnosed by the failure diagnosis server 16. The upper portion of the work request screen 15a shows reception information on the reception number, the name and address of a client or a work place, etc. In the case where a work item is urgent, a receptionist or the like puts a check mark in an urgent check box 15b. A “Phenomenon” display section displays information about a problem on a machine reported by a client. On the “Phenomenon” display section, the status can be selected from a list of failure statuses which are displayed on another screen by depressing a select button 15c or a failure status can be input in a status supplement field. FIG. 3 shows an example in which “abnormal sound generated at the time of printing” is input in the status supplement field. After an entry is made in the “Phenomenon” display section, depressing a failure diagnosis button 15d on a diagnosis display section sends information input on the “Phenomenon” display section to the failure diagnosis server 16 which conducts diagnosis upon reception of that information. At this time, the failure diagnosis server 16 further sends an inquiry for specifying a failure status, if needed, to the service department terminal 15 and receives a reply input by the receptionist or the like. The failure diagnosis server 16 sends the service department terminal 15 failure information including the cause of a failure, a repair method, and the part codes and quantity of parts needed for a repair. This failure information may be one piece or plural pieces for a single work request from a client. That is, the failure diagnosis server 16 extracts possible several failure causes from failure statuses received from a client, extracts the associated repair method or the like and sends them. The service department terminal 15 receives that information. When the failure information is displayed on the display section of the service department terminal 15 and a single piece of failure information is settled by the receptionist at the management center, the settled failure information is displayed on the “Diagnosis” information display section of the work request screen 15a. When a request button 15e displayed at the lower portion is depressed, information on a repair method, and needed parts or the like is sent to the management server 11 and the detailed reception information memory section 21 is updated.

Next, a work status monitoring screen 15f to be displayed on the display section of the service department terminal 15 will be described referring to FIG. 4.

The work status monitoring screen 15f shows a map display section 15g, a date display section 15h, a reception number display section 15i, a worker display section 15j, a travel-time display button 15k and a notification button 15m. The map display section 15g shows a map showing individual areas and its magnification changes as radio buttons to select the magnification, provided at the lower portion of the screen, are selected. When a date is input on the date display section 15h, the map display section 15g showing the work place of a work request which has the date as a scheduled work date can be displayed. The map display section 15g shows a work place button 15n showing a work place and a worker location button 15p showing the location of the worker. Each of those positions is acquired by converting the longitude and latitude stored in each memory section to (x, y) information indicating which point (coordinates) in the map file of the bit-map format corresponding to that position. With regard to the work place, (x, y) information is acquired by the longitude and latitude of the client information memory section 22 and the work place button 15n is displayed. With regard to the location of the worker, (x, y) information is acquired by the longitude and latitude from the detailed worker information memory section 24 and the worker location button 15p is displayed. Viewing the map display section 15g, therefore, the work manager can acquire information on the relative distance between the work place or the place of a client code and the location of the worker, and an imbalance in the number of work requests from one area to another.

The work place button 15n is shown by the reception number of the work and characters are displayed in red in case of an urgent work item. The worker location button 15p is shown by a number assigned to each worker. As the longitude and latitude of the worker terminal 13 are acquired regularly (e.g., at 10-minute intervals), the worker location button 15p is updated as needed. Clicking the work place button 15n, a user can view detailed information of the work request, such as the reception number, address, machine type and required skill, on a separate screen (not shown). Clicking the worker location button 15p, the user can view information of the worker, such as the machine type to be handled by the worker and the worker's skill, on a separate screen (not shown). When the reception number is entered in the reception number display section 15i, the numbers of workers present within 5 km (workable condition) from the work place of the work request to which the reception number is assigned are displayed on a pull-down menu. Accordingly, the work manager selects a worker that meets the requirements for the type of a machine to be a work target and the required skill from workers displayed on the worker display section 15j. With the number of the worker entered in the worker display section 15j, when the user clicks the travel-time display button 15k, a travel route and travel time are displayed on a separate screen (not shown). The work manager can therefore select a worker whose travel time is short.

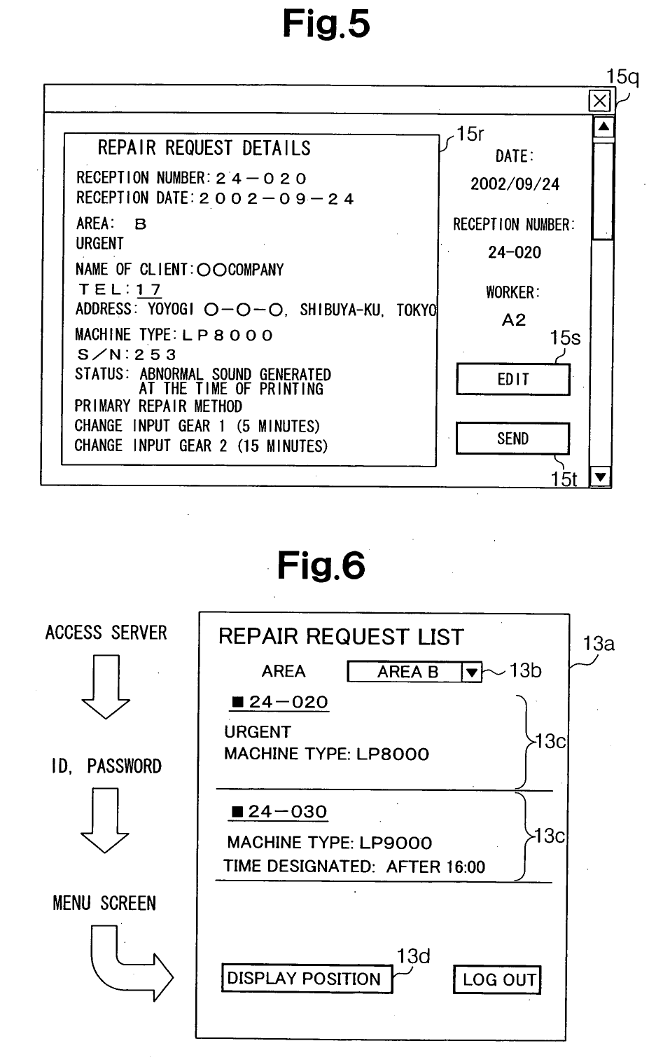

With the reception number entered in the reception number display section 15i and the number of the worker entered in the worker display section 15j, when the user clicks the notification button 15m, a notification screen 15q shown in FIG. 5 is displayed. The notification screen 15q shows a request details display section 15r, an edition button 15s and a transmission button 15t. The request details display section 15r shows information for a work item selected on the work status monitoring screen 15f, and shows the reception number, the reception date, the work area and work category of the work place, whether a work item is urgent or not, client information and information on a failure. When the transmission button 15t is clicked, an e-mail including the content of the request details display section 15r is sent to the worker terminal 13 of the worker who is shown on the upper right portion of the screen. When the edition button 15s is clicked, the content of the request details display section 15r can be edited via input means, such as a keyboard, which the service department terminal 15 has. The worker who has received the e-mail accesses the management server 11 from the worker terminal 13 and performs an operation for accepting the work item from the screen displayed on the display section.

Next, the display screen that is displayed on the display section of the worker terminal 13 will be discussed referring to FIGS. 6 to 8. When there is no accepted work remaining as in a case where all the work items are finished, the worker uses the worker terminal 13 to access the management server 11 over the network N in order to obtain a new work item. The web server 14 in the management server 11 sends information of an initial screen (not shown) for entering an ID and password to the worker terminal 13 and the worker inputs the ID and password.

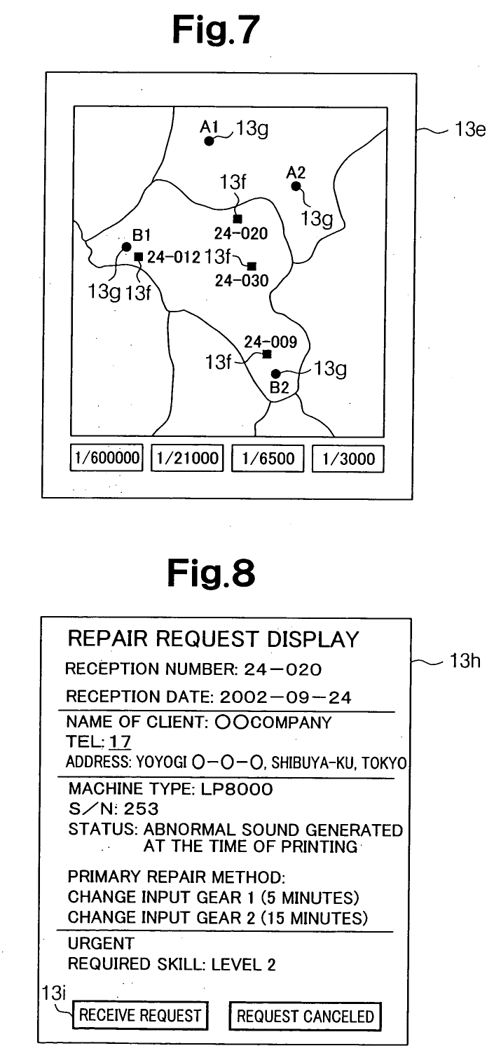

After verifying the ID and password, the management server 11 displays a menu screen (not shown) on the display section of the worker terminal 13. When the worker selects a “List of repair requests”, one item in the menu screen, the management server 11 extracts a work area code of the worker corresponding to the received ID. Then, the management server 11 displays a request list screen 13a shown in FIG. 6 or a screen in the area that corresponds to the work area code. The request list screen 13a shows an area selection field 13b, a reception information display section 13c and a position display button 13d. In the area selection field 13b, a desired area can be selected from all the areas and when an area is selected, the request list screen 13a of the selected area is displayed. The management server 11 displays the request list screen 13a of the work area of the worker who has made an access, as the initial screen of the request list screen 13a. The reception information display section 13c shows information about a work request, such as the reception number, whether a work item is urgent or not, the machine type and the time designated. In the case where there is no work request on the day for which the request list screen 13a is displayed, information for the work request is not displayed and a report for termination of the work request item, such as “no work request today” is displayed. When the worker selects an area outside the worker's work area in the area selection field 13b, the request list screen 13a shows information for a work request which is an item of a work request in the selected area and has been generated within 5 km from the location of the worker. When the position display button 13d at the lower position of the list is selected, a map screen 13e in FIG. 7 is displayed.

The map screen 13e in FIG. 7 shows a work place display 13f and a worker location display 13g indicating the location of each worker. The work place display 13f is shown by the reception number and the worker location display 13g is shown by the number of each worker. As in the work status monitoring screen 15f which is displayed on the display section of the service department terminal 15, each of these positions is acquired by converting the longitude and latitude stored in each memory section to (x, y) information indicating which point (coordinates) in the map file of the bit-map format of that position. When a reception number on any work place display 13f or a reception number in the request list screen 13a is pressed, information of the associated case is displayed on the next screen. When the reception number “24-020” is pressed, for example, a request details screen 13h shown in FIG. 8 corresponding to the reception number “24-020” is displayed.

The request details screen 13h in FIG. 8 shows the reception number, reception date, client information, information on the machine type or the like, the status of the machine when the request was made, a repair method for the machine status, an expected time for the repair, and parts needed for the repair. As apparent from the above, the worker selects a work item to accept through the request details screen 13h and the map screen 13e in consideration of whether the work item is urgent or not, whether there is a designated worker, the expected time, the machine type and the relative distance between the place of the client and the location of the worker. When the worker presses a case reception button 13i, a progress update command is sent to the management server 11 to allow the worker to accept the work item. The management server 11 updates the detailed reception information memory section 21.

The following will describe various procedures for assisting a worker with a work item in the worker assisting system provided by the management server 11.

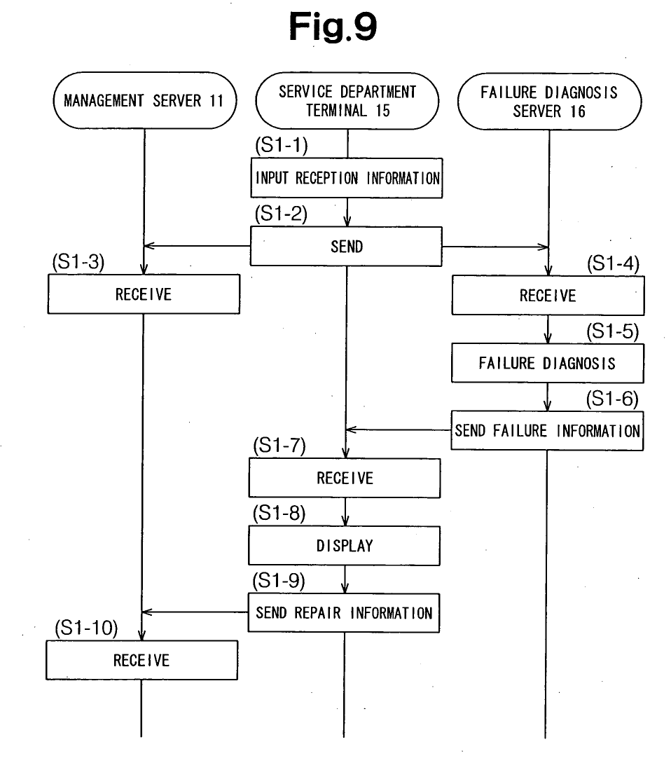

First, procedures for receiving a request from a client will be discussed referring to FIG. 9. A receptionist or the like working at the management center receives a work request from a client by telephone or e-mail or the like. The work request is made when a machine already located at a site has a problem. The receptionist acquires information on a client code or client name, the type of a machine, a serial number and a failure status or the like from a client and inputs the information through the service department terminal 15. The receptionist further inputs information on the reception number, reception date, scheduled work date, urgency of a work item when needed, designation of a time and designation of a worker through the service department terminal 15 (S1-1). When those pieces of information are input through the service department terminal 15, the service department terminal 15 sends the information to the management server 11 and the failure diagnosis server 16 (S1-2). The management server 11 receives the information and stores it in the reception information memory section 20 (S1-3). The failure diagnosis server 16 receives those pieces of information first (S1-4) and performs failure diagnosis based on the information (S1-5). Through the failure diagnosis, failure information, such as the cause of the failure, repair method, parts needed for the repair and the expected time needed for the repair, is output and sent to the service department terminal 15 (S1-6). This failure information has a plurality of repair methods proposed on the assumption that there are normally a plurality of causes. The service department terminal 15 receives the failure information (S1-7) and display the information on the display section (S1-8). Then, the receptionist or the like located at the management center selects information which seems most probable from the displayed plural pieces of failure information. With the failure information selected, the service department terminal 15 sends the selected failure information to the management server 11 (S1-9). The management server 11 receives the failure information and stores the reception number, repair method, expected time, codes of needed parts and the quantity of the parts (S1-10).

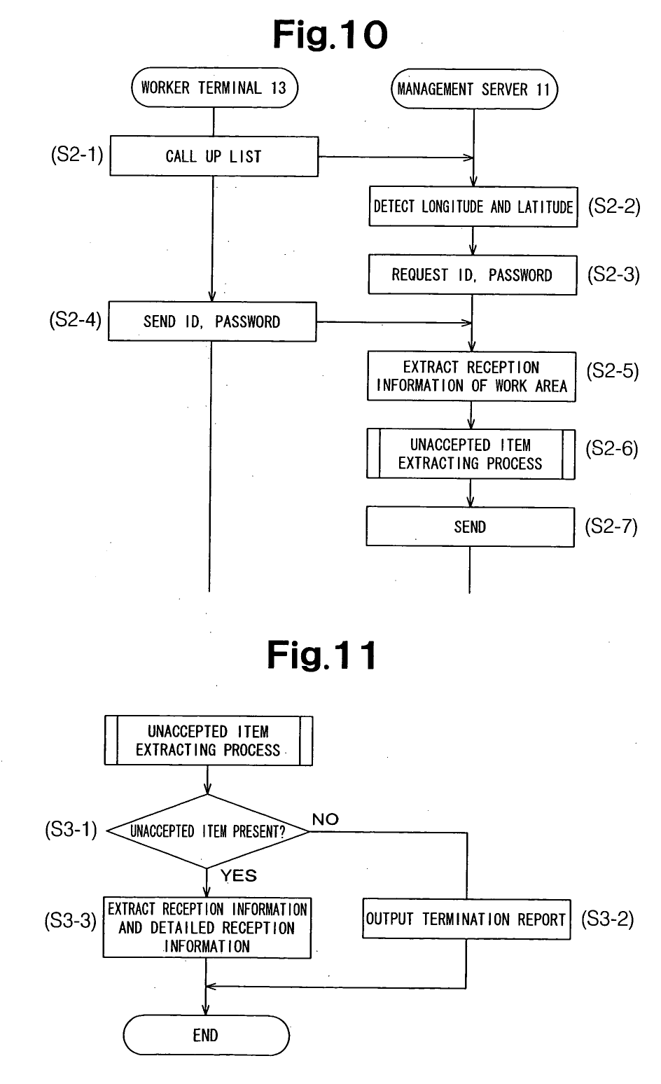

Next, procedures for a worker to accept a work item will be discussed referring to FIG. 10. In the case where the worker has no further work items for which the worker takes charge or receives an instruction from the management center or a similar case, the worker accesses the management server 11 to call up the work request list using the worker terminal 13 (S2-1). In response to the access, the management server 11 detects the longitude and latitude of the worker terminal 13 (S2-2). Then, the management server 11 requests an ID and password (S2-3). The worker sends the ID and password from the worker terminal 13 (S2-4) and the management server 11 performs verification. Then, the management server 11 extracts the work area code corresponding to the received ID from the worker information memory section 23 and extracts reception information containing the area code corresponding to the work area code from the reception information memory section 20 (S2-5). Further, an unaccepted item extracting process is carried out to determine if there is unaccepted information in the extracted reception information (S2-6).

This process will be discussed referring to FIG. 11. In the unaccepted item extracting process, first, the worker code in the detailed reception information corresponding to the extracted reception information is searched to determine whether or not this worker code is present (S3-1). That is, the management server 11 determines whether or not there is an unaccepted item. In the case where there is no unaccepted reception information (NO in S3-1), a report for terminating the work request item, such as “no work request today”, is output (S3-2). In the case where there is unaccepted reception information (YES in S3-1), information needed for the work item is extracted from the unaccepted reception information and the detailed reception information corresponding to this reception information (S3-3), after which the unaccepted item extracting process is terminated. Then, the information extracted in the unaccepted item extracting process or a report for the termination of the work request item is sent to the worker terminal 13 (S2-7). The worker terminal 13 displays a message, such as “no work request today”, when there is no work request for the work area of which the worker takes charge (hereinafter sometimes referred to as “covering work area”), and displays information on the work request when there is one.

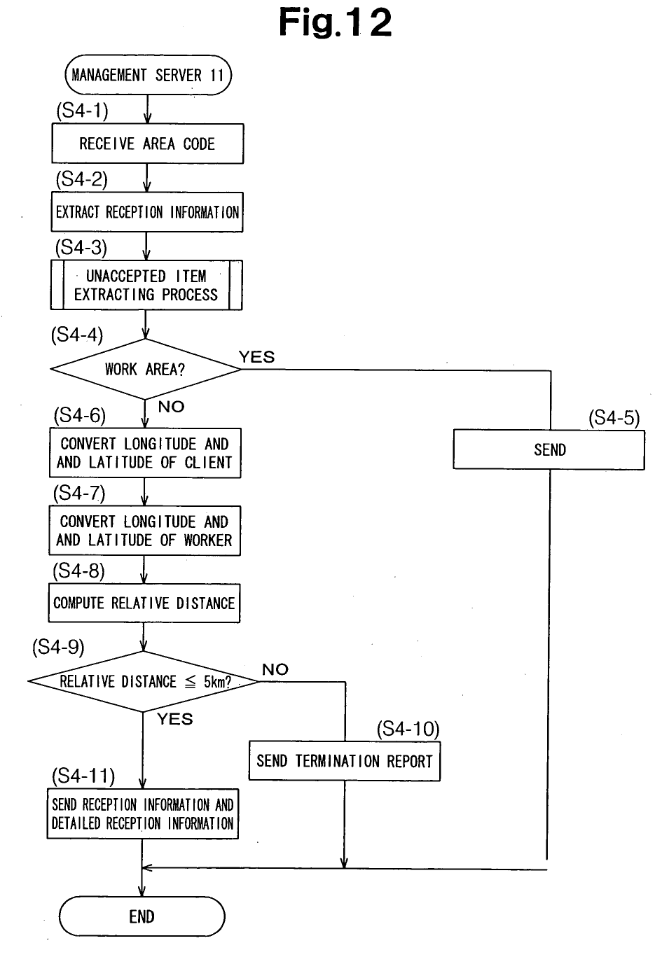

Referring now to FIG. 12, a description will now be given of procedures in the processing in the management server 11 in the case where a work area is selected afresh in the area selection field 13b of the request list screen 13a. The worker performs work items in the covering work area with the highest priority. Therefore, the initial screen of the request list screen 13a shows a list of work items in the covering work area. Although the worker checks the screen of the covering work area first, the worker may view the screen of an area other than the worker in charge in some cases. The latter cases include a case where the worker has no more work requests in the covering work area and a case where the worker has received an e-mail instructing acceptance of a work request in another work area from the work manager at the management center. One example of the case where an instruction to accept a work request in another work area is sent is a case where many urgent work requests are present in one work area and the work manager has decided that the worker in charge of that work area cannot handle those work requests. In those cases, the worker selects a work area other than the covering work area in the area selection field 13b on the request list screen 13a. The worker may go back to the request list screen 13a of his or her own covering work area after viewing the request list in a work area other than the covering work area. As apparent from above, at the time of viewing the request list screens 13a of plural work areas, the worker selects the desired work area in the area selection field 13b on the request list screen 13a. The management server 11 receives area code information of the selected work area which is sent from the worker terminal 13 at a time work area is selected afresh in the area selection field 13b (S4-1).

The management server 11 extracts reception information corresponding to the area code (S4-2) and carries out the unaccepted item extracting process (S4-3). Further, the management server 11 determines whether or not the received area code is the identifier of the work area of which the worker is in charge based on the ID already received (S4-4). Specifically, the management server 11 detects the covering work area code for the worker information that holds the received ID and determines whether or not the covering work area code is identical to the area code.

When the area code is identical to the covering area code (YES in S4-4), the management server 11 sends information on an unaccepted work request item in the covering work area or a report for termination of the work request item (S4-5) and terminates the process. When the received area code is not identical to the covering area code (NO in S4-4), on the other hand, the management server 11 extracts the longitude and latitude of the place of the client who made the extracted, unaccepted work request item. Specifically, the client code stored in the unaccepted reception information is extracted and the longitude and latitude in the client information in the client information memory section 22 where this client code is stored are extracted. Then, the longitude and latitude are converted to (x, y) information indicating on which point (coordinates) in the map file of the bit-map format the longitude and latitude lie (S4-6). Next, the longitude and latitude of the worker terminal 13 which are detected at the time the worker terminal 13 has made an access are likewise converted to (x, y) information (S4-7). Further, the relative distance between the location of the worker and the client is computed from the (x, y) information of the location of the worker and the (x, y) information of the place of each client (S4-8). Then, the management server 11 determines whether the computed relative distance falls within 5 km or not (S4-9). When the computed relative distance is greater than 5 km (NO in S4-9), the management server 11 sends a termination report such as “no available work request” (S4-10) and terminates the process. When the computed relative distance is within 5 km (workable condition) (YES in S4-9), the management server 11 extracts necessary information from the reception information and detailed reception information of the client, sends the information to the worker terminal 13 (S4-11) and terminates the process.

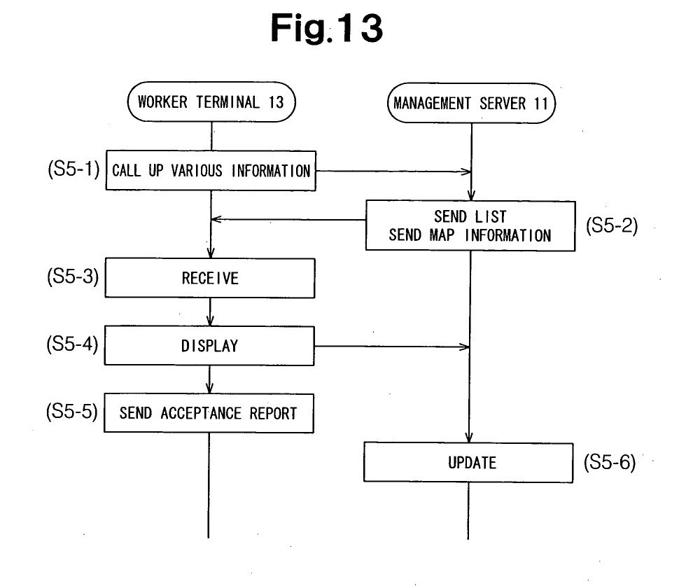

Next, procedures for the worker to accept a work item will be discussed referring to FIG. 13.

The worker calls up the request list screen 13a and the map screen 13e using the worker terminal 13 (S5-1). In response to this action, the management server 11 sends information for displaying the request list screen 13a and the map screen 13e (S5-2). The worker terminal 13 receives those pieces of information (S5-3) and displays them on the display section (S5-4). Then, the worker selects a work item to accept in consideration of the machine type, required skill, relative distance and so forth which are readable from the request list screen 13a and the map screen 13e. When the worker selects one work item and selects the case reception button 13i, a progress update command is sent to the management server 11 as a report of acceptance (S5-5). Upon reception of the progress update command, the management server 11 sets the progress code of the selected work and the progress code of the worker to “01” indicating the work item as accepted. Then, the worker code is stored in the detailed reception information to update the detailed worker information and detailed reception information (S5-6).

The first embodiment has the following advantages.

(1) In the first embodiment, when a work area other than the work area for which the worker takes charge is selected on the request list screen 13a, the management server 11 computes the relative distance between the location of the worker and the place of a client from the longitude and latitude of the location of the worker and the longitude and latitude of the place of the client. Then, reception information showing the relative distance lying within 5 km and the associated detailed reception information are extracted from unaccepted reception information on the work area other than the covering work area. Then, information necessary for the work item, such as the reception number, the machine type, the required skill and information on the client, is extracted from the extracted pieces of information and sent to the worker terminal 13. In the case where the worker has no more work items available in the worker's own covering work area or so, the worker can accept a work item in a work area other than the covering work area and lying within 5 km from the location of the worker, as needed. Therefore, work items can be handled efficiently as a whole. Even in the case where the management center instructs the worker to accept a work item in another work area, the worker can check information for a work request.

(2) In the first embodiment, the longitude and latitude of the location of the worker are regularly detected by the GPS function equipped within the worker terminal 13 and are stored in the detailed worker information memory section 24. The longitude and latitude of the place of a client are stored in the client information memory section 22. This makes it possible to display the location of the worker on the map screen 13e and the work status monitoring screen 15f nearly in real time and to display the place of the client where the work is to be performed on the map screen 13e and the work status monitoring screen 15f. Therefore, the worker can determine the relative distance between the place of the client and the location of the worker and can take the relative distance into consideration at the time of accepting the work. The supervisor (manager) can grasp the number of work requests for each work area, the imbalance between work places, the relative distance between the work place or the place of the client and the location of the worker and the relative distance between individual workers, thus making it possible to effectively monitor the entire work area.

(3) In the first embodiment, the relative distance between the work place or the place of the client and the location of the worker is computed by converting the longitude and latitude of the location of the worker to (x, y) information on a map file. This can permit the use of the longitude and latitude of the location of the worker that are detected by the position detecting means so that the relative distance can be computed in real time.

(4) In the first embodiment, information on the type of a machine to be a work target, whether a work item is urgent or not, the skill required for a work item, etc. is displayed on the request details screen 13h of the worker terminal 13. At the time the worker selects a work item to accept, therefore, the worker can make the selection in consideration of those pieces of information and can thus do the work efficiently.

(5) In the first embodiment, in the case where work requests cannot be handled by a worker in a single work area alone or so, a worker in another work area who is chosen to accept a work item is selected on the work status monitoring screen 15f displayed on the display section of the service department terminal 15. Then, information on a work request is sent to the worker by e-mail through the notification screen 15q. In the case where there is a work area which involves a lot of work requests or a work area where an urgent work request has been generated or in a similar case, an instruction is sent to a worker who is near the work area but who takes charge of another work area to instruct the worker to accept the work item. This can allow work items as a whole to be performed efficiently.

(6) In the first embodiment, a work request is displayed on the request list screen 13a area by selecting a work area in the area selection field 13b. This can allow the worker to view work request items of the worker's own covering work area with priority.

(7) In the first embodiment, at the time the worker accepts a work item selected by the worker, a progress update command is transmitted from the worker terminal 13. In response to this progress update command, the progress code of the selected work item and the progress code of the worker are set to “01”, which indicates the work item as accepted and the worker code is stored in detailed reception information. This makes it unnecessary for the worker to call the management center by telephone to set the work acceptance, thus suppressing the occurrence of miscommunication. In addition, at the time of extracting unaccepted reception information whose progress code is “00”, it is possible to search the reception information whose worker code is stored in the associated detailed reception information and discriminate whether or not there is such unaccepted reception information.

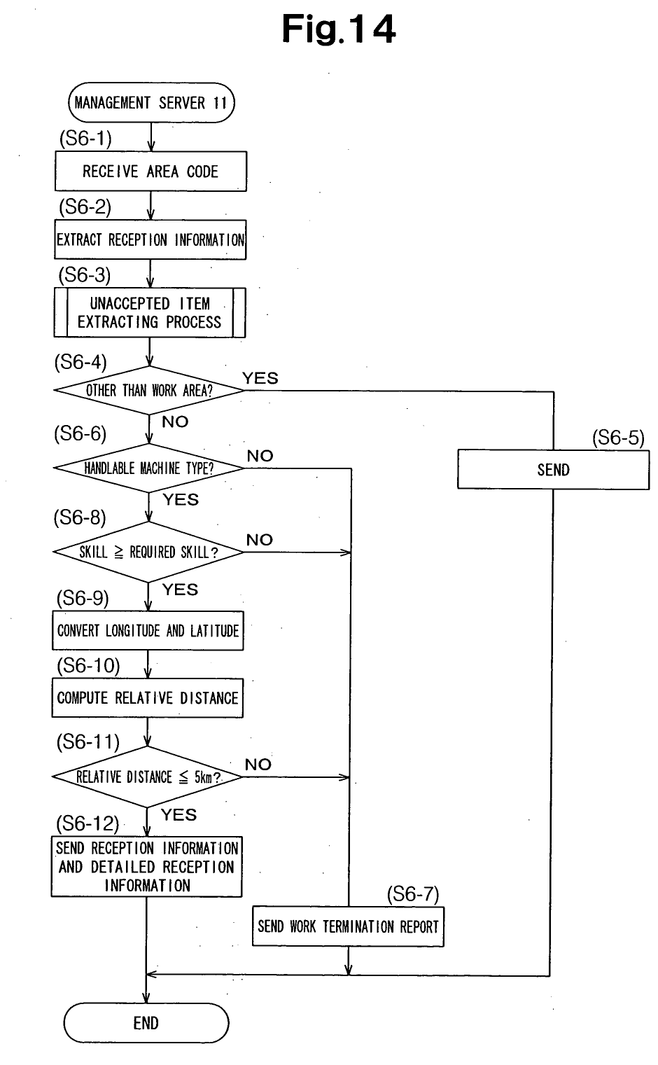

The second embodiment of the worker assisting system embodying the present invention will be described below referring to FIG. 14. Because the second embodiment differs from the first embodiment only in the structure where procedures for the processing in the management server 11 of the first embodiment in the case where a work area is selected afresh are modified, the detailed descriptions of similar portions will be omitted.

When the worker selects a work area afresh in the area selection field 13b on the request list screen 13a displayed on the display section of the worker terminal 13, the management server 11 receives area code information of the selected work area (S6-1). The management server 11 extracts reception information corresponding to the area code (S6-2) and executes the unaccepted item extracting process (S6-3). Then, the management server 11 determines based on the ID already received whether or not this area code is the identifier of the work area for which the worker takes charge (S6-4). When the area code is identical to the covering area code (YES in S6-4), the management server 11 sends information on an unaccepted work request item or a report for termination of the work request item (S6-5) and terminates the process. When the received area code is not identical to the covering area code (NO in S6-4), on the other hand, the management server 11 determines whether or not the target of a work request item extracted in the unaccepted item extracting process is a machine type that can be handled (S6-6). Specifically, the machine type stored in the unaccepted reception information is compared with the coverable machine types in the worker information where the ID already received is stored. Then, it is determined whether or not the machine type in the work request is included in the machine types that can be handled by the worker. In the case where the machine type in the unaccepted work request cannot be handled (NO in S6-6), a termination report, such as “no available work request”, is output and sent to the worker terminal 13 (S6-7). In the case where the machine type in the unaccepted work request can be handled (workable condition) (YES in S6-6), it is determined whether or not the required skill of the work request item is equal to or less than the skill of the worker (S6-8). Specifically, the required skill in the detailed work information corresponding to the unaccepted work request item is compared with the skill listed in the worker information where the ID already received is stored. The required skill and the skill of the worker are given by numerals, e.g., “1”, “2” and so forth, and as the numeral becomes greater, a work item with a higher degree of difficulty can be handled.

In the case where the required skill is greater than the skill of the worker, e.g., when the required skill is “3” and the skill of the worker is “2” (NO in S6-8), the management server 11 sends a report, such as “no available work request”, to the worker terminal 13 (S6-7) and terminates the process. When the required skill is equal to or less than the skill of the worker (workable condition) (YES in S6-8), the longitude and latitude of the client and the longitude and latitude of the worker are converted to (x, y) information indicating which points (coordinates) in the map file of the bit-map format the positions are (S6-9). Then, the relative distance between the place of the client and the location of the worker is computed from the (x, y) information of the client and the (x, y) information of the worker (S6-10). It is then determined for each client whether or not the relative distance lies within 5 km (S6-11).

When the relative distance is greater than 5 km (NO in S6-11), a termination report is sent (S6-7) and the process is terminated. When the relative distance lies within 5 km (workable condition) (YES in S6-11), necessary information is extracted from the reception information for the client and the detailed reception information corresponding to this reception information and is sent to the worker terminal 13 (S6-12) after which the process is terminated. In the case where a work area other than the covering work area is selected on the worker terminal 13, as apparent from the above, information on an unaccepted work request issued within 5 km from the location of the worker is received when the machine type can be handled by the worker and the required skill is met and such a work request exists, and “no available work request” is displayed when such a work request does not exist. In the case where information on the work request is received, the worker chooses a work item to accept in consideration of whether there is a designated time or not, the relative distance and so forth, which are readable from the request list screen 13a and the map screen 13e. When the worker selects one work item and selects the case reception button 13i, a progress update command is sent to the management server 11, and the management server 11 sets the progress code of the selected work item and the progress code of the worker to “01” indicating the work item as accepted. Then, the worker code is stored in the detailed reception information to update the detailed worker information and detailed reception information.

The second embodiment has the following advantages in addition to the advantages (2) to (7) of the first embodiment.

(8) In the second embodiment, when a work area other than the work area for which the worker takes charge is selected on the request list screen 13a, information on a work item whose target is a machine type of which the worker takes charge, whose required skill is equal to or less than the skill of the worker and which is to be done at a place within 5 km from the location of the worker is extracted from unaccepted reception information of a work area other than the covering work area. The detailed reception information corresponding to this reception information is also extracted. The reception number, client information, etc., which is information needed for the work item, is extracted from those extracted pieces of information and sent to the worker terminal 13. In the case where the worker has no further work items for which the worker takes charge or so, the worker can accept that work item of a work area located within 5 km from the location of the worker and other than the covering work area for which the worker can handle, as needed. Therefore, work items can be handled efficiently as a whole. Even in the case where there an instruction to accept a work item of another work area is sent from the management center, the worker can check information for the work request.

(9) In the second embodiment, at the time reception information for a machine type of which the worker is in charge is extracted from unaccepted reception information, information on the machine type included in the reception information is compared with the coverable machine types in the worker information. As information extraction is carried out by procedures for comparing two kinds of identifiers with each other, therefore, necessary information can be extracted relatively easily. At the time reception information for a work item that is equal to the required skill or less than the skill of the worker is extracted from unaccepted reception information, information on the required skill included in the detailed reception information is compared with the worker's skill in the worker information. As information extraction is likewise carried out by procedures for comparing two kinds of identifiers with each other, therefore, necessary information can be extracted relatively easily.

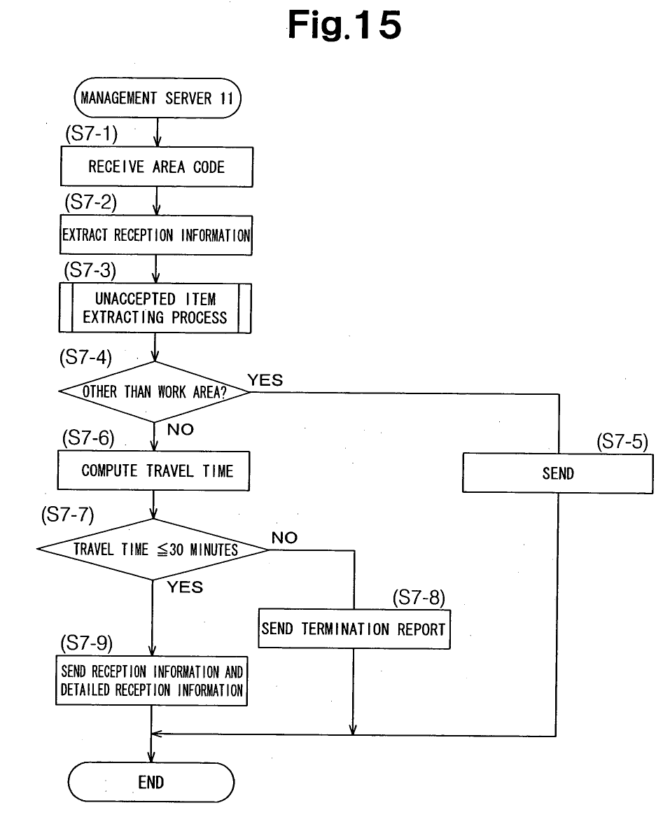

The third embodiment of the worker assisting system embodying the present invention will be described below referring to FIG. 15. Because the third embodiment differs from the first embodiment only in the structure where procedures of the processing in the management server 11 of the first embodiment in the case where a work area is selected afresh are modified, the detailed descriptions of similar portions will be omitted.

When the worker selects a work area afresh in the area selection field 13b on the request list screen 13a displayed on the display section of the worker terminal 13, the management server 11 receives area code information of the selected work area (S7-1). The management server 11 extracts reception information corresponding to the area code (S7-2) and executes the unaccepted item extracting process (S7-3). Then, the management server 11 determines based on the ID already received whether or not this area code is the identifier of the work area for which the worker takes charge (S7-4). When the area code is identical to the covering area code (YES in S7-4), the management server 11 sends information on an unaccepted work request item in the covering work area or a report for termination of the work request item (S7-5) and terminates the process. When the received area code is not identical to the covering area code (NO in S7-4), on the other hand, the route to each client is searched for an extracted unaccepted work request item of a work area other than the covering work area according to the route search program stored in the management server 11 using the longitude and latitude of the place of the client and the longitude and latitude of the location of the worker. Then, the travel time from the location of the worker to the place of the client is computed (S7-6). Further, it is determined whether or not the computed travel time falls within 30 minutes (S7-7).

When the computed travel time exceeds 30 minutes (NO in S7-7), a termination report, such as “no available work request”, is output and sent to the worker terminal 13 (S7-8). When the computed travel time falls within 30 minutes (workable condition) (YES in S7-7), information necessary for the work item is extracted from the reception information and detailed reception information that corresponds to the work request and is sent to the worker terminal 13 (S7-9). In the case where a work area other than the covering work area is selected on the worker terminal 13, as apparent from the above, information on an unaccepted work request issued within a distance of a 30-minute travel time from the location of the worker is received when such a work request exists, and “no available work request” is displayed when such a work request does not exist. In the case where information on the work request is received, the worker further decides on a work item to accept in consideration of the machine type, the required skill, the presence/absence of a designated time, the relative distance and so forth, which are readable from the request list screen 13a and the map screen 13e. When the worker selects one work item and selects the case reception button 13i, a progress update command is sent to the management server 11, and the management server 11 sets the progress code of the selected work item and the progress code of the worker to “01” indicating the work item as accepted. Then, the worker code is stored in the detailed reception information to update the detailed worker information and detailed reception information.

The third embodiment has the following advantages in addition to the advantages (2) to (7) of the first embodiment.

(10) In the third embodiment, when a work area other than the work area for which the worker takes charge is selected on the request list screen 13a, the travel time from the location of the worker to the place of the client is computed and reception information including the travel time lying within 30 minutes is extracted from unaccepted reception information for a work area other than the covering work area. The detailed reception information which corresponds to this reception information is also extracted. The reception number, whether or not the work is urgent, the required skill, client information, etc., which is information needed for the work item, is extracted from those extracted pieces of information and sent to the worker terminal 13. In the case where the worker has no further work items for which the worker takes charge or so, the worker can accept a work item for which the travel time from the location of the worker is within 30 minutes, as needed. Therefore, work items can be handled efficiently as a whole. Even in the case where there an instruction to accept a work item of another work area is sent from the management center, the worker can check information for the work request.

This embodiment may be modified as follows. Although the management server 11 is provided with the capability to act as the web server 14 in each embodiment discussed above, the management server 11 and the web server 14 may be provided separately. This system can manage the management server 11 and the web server 14 separately.

In the embodiments discussed above, each is provided with the failure diagnosis server 16 connected to the management server 11. Instead of this structure, the receptionist or the like at the management center may search and extract the cause of a failure, the repair method and necessary parts using failure information, which contains the causes of failures and repair methods, and a data base in which information on parts necessary for repairs is stored.

In the individual embodiments, a work request from a client is received by telephone or e-mail or the like. Instead, a client may access the failure diagnosis server 16 over the network (not shown), display individual screens on the terminal used by the client and diagnose the failure based on information sent from the failure diagnosis server 16, and transmit a work request to the failure diagnosis server 16. At this time, the work request transmitted to the failure diagnosis server 16 is sent to the management server 11 and is stored in the reception information memory section 20 and the detailed reception information memory section 21. This method can reduce the burden on the receptionist and work manager at the management center.

The individual embodiments may be modified in such a way that when a number for each worker displayed on the map screen 13e is selected on the worker terminal 13, the progress state can be displayed based on the worker code and name of that worker and a progress code stored in detailed worker information. This method can allow the progress states of other workers to be used as data for the decision in selecting the next work item, so that a work item, can be selected appropriately.

The service department terminal 15 may display the progress management screen for each worker. This screen shows the worker code and name of each worker and shows either a status indicating the worker as having no work or the worker performing a work item based on the progress code reported from the worker. This method can allow the work supervisor (manager) to adequately grasp the overall progress.

In the individual embodiments, when the management server 11 receives a work completion report, the progress code in detailed worker information is set to “03” or is set to indicate a work item as completed. Instead, when the management server 11 receives a work completion report after the progress code in detailed worker information is set to “02” (working), the detailed worker information and the corresponding reception information may be deleted. This method can prevent the amount of data to be stored in each memory section of the management server 11 from becoming larger.

In the individual embodiments, based on the workable condition, the management server 11 extracts reception information on a work item that can be handled by a worker in charge from unaccepted reception information in a work area other than the covering work area of the worker and sends the reception information to the worker terminal 13. Instead, the workable condition may be changed to another one, such as the priority of a client being higher than a predetermined priority.

In the individual embodiments, the receptionist or the like receives a work request from a client by telephone or e-mail or so. The notification of a work request from a client includes a notification that is automatically sent from a machine located at the place of the client. In this case, the machine that is to be repaired or the work target has a function for automatically sending information indicating the occurrence of a failure or an event that requires maintenance to the management server 11 when a failure or such an event occurs. The information includes data on the client code, serial number, status, urgency, etc. Upon reception of those pieces of information, the management server 11 stores various kinds of information in the reception information memory section 20 as reception information and performs the above-described processes. Or, the machine that is to be repaired or the work target has a function for sending a notification to the management server 11 when the display or a button provided on the machine is operated. That is, when a client decides that maintenance is needed, for example, the client sends information indicating a work request to the management server 11 by operating the display or the like provided on the machine. Upon reception of those pieces of information, the management server 11 stores the information in the reception information memory section 20 as reception information and performs the above-described processes.

In the individual embodiments, the management server 11 constitutes the computer system in which a worker who performs a work item, such as repair, maintenance or the like of a machine in a work area for which the worker takes charge, accepts work in a work area other than the covering work area using the worker terminal 13. Work items the worker does include, for example, is work which does not involve the operation of a machine at the place of the client, such as delivery of consumables like paper and toner, and parts. In this case, the failure diagnosis server 16 does not perform failure diagnosis. The computer system which is constituted by the management server 11, etc. may be used as a system that is used in companies in the so-called service industry which does not provide goods, such as a financial company, distribution company and consulting company, besides the system that assigns a work item requested by a client to a worker who perform repair, maintenance and so forth. In this case, the failure diagnosis server 16 also does not perform failure diagnosis. Further, the computer system that is constituted by the management server 11, etc. is not limited to a system that assigns work items only to workers who travel to places of clients, but has only to distribute, to workers in charge of different work categories, work items for work categories other than those work categories. At this time, the management server 11 does not impose the condition that the relative distance from the place of the client is within a predetermined distance and the condition that the travel time to the place of the client lies within a predetermined time as a workable condition.

In the individual embodiments, the computer system that is constituted by the management server 11, etc. may be a system which is used by a plurality of business entities. For example, the computer system may be a system that is shared by a plurality of business entities of the same business field and which repair and maintain machines. The computer system may also be a system that is shared by business entities of different business fields, such as a business entity that repairs and maintains machines, or a distribution company and a sales company that delivers commodities. In this case, for example, the management server 11 has the reception information memory section 20 for each business company and stores identifiers assigned category-by-category in the worker information memory section 23. At the time each worker accesses the management server 11, the management server 11 specifies a category to which the worker belongs based on worker information using an ID or the like sent from the worker terminal 13. Further, the management server 11 extracts unaccepted reception information stored in the reception information memory section 20 that corresponds to the specified category and performs various processes.

In the individual embodiments, information about the priority indicating whether a contract is closed or not may be stored in the client information memory section 22. At the time the management server 11 extracts unaccepted reception information, the management server 11 may extract priority information corresponding to that reception information and set rankings based on the priority information. Then, the management server 11 may arrange the request items according to the rankings and display them in that form on the request list screen 13a displayed on the display section of the worker terminal 13. Alternatively, the management server 11 may display the priority on the request list screen 13a.

Although the worker information memory section 23 is provided in the management server 11 in the embodiments discussed above, the worker information memory section 23 may be omitted from the management server 11 and provided in the worker terminal 13 instead. In this case, at the time the worker terminal 13 accesses the management server 11 according to the worker's operation, the worker terminal 13 sends worker information such as the worker code and work area code, to the management server 11. Upon reception of the worker information, the management server 11 temporarily stores the worker information in a RAM or an unillustrated memory section and then performs various processes. This modification eliminates the need to register worker information in the management server 11 beforehand so that even when the worker information is changed, the worker information stored in the worker terminal 13 has only to be updated.

Although the embodiments of the invention have been described in connection with the accompanying drawings, the present invention is not limited to those embodiments but may be modified within the scope of the appended claims and their equivalents.

1. A method of using a computer system to assist a worker who takes charge of a predetermined work category by providing the worker with information of a work item outside the work category, the computer system having a first memory device for storing reception information on goods or service requests and a second memory device for storing worker information on the worker, the method comprising the steps of:
extracting reception information about a request outside the work category of the worker and in an unaccepted state from the reception information stored in the first memory device based on the worker information;
extracting reception information about a request which can be handled by the worker from the reception information based on a predetermined condition;
sending the reception information extracted based on the predetermined condition to a terminal possessed by the worker; and
updating the selected reception information to an accepted state from an unaccepted state upon reception of notification that the reception information sent to the terminal has been selected by the worker.

2. A method of using a computer system to assist a worker who takes charge of a predetermined work area and travels to and works at a work place by providing the worker with information of a work item outside the work area, the method comprising the steps of:
storing in a memory device work reception information which is information on an accepted work request from a client and which includes information about a work place indicating a location for the accepted work request and work request information that is needed when fulfilling the accepted work request;
extracting work reception information outside the work area of the worker and in an unaccepted state from the work reception information stored in the memory device,
computing a relative distance between the work place included in the extracted work reception information, the location of the worker and the work place;
extracting work reception information showing that the relative distance lies within a predetermined distance from the extracted work reception information;
extracting work request information included in the extracted work reception information and sending that work request information to a terminal possessed by the worker; and
updating the work reception information corresponding to the selected work request information to an accepted state from an unaccepted state when the work reception information sent to the terminal is selected by the worker.

3. The method according to claim 2, wherein the work reception information further includes at least an identifier for the work reception information and information on a type of a machine to be a work target.

4. The method according to claim 2, wherein the work reception information further includes information on a longitude and a latitude representing the work place.

5. The method according to claim 2, further including the stage of storing a longitude and a latitude representing a location of the worker acquired by a position detecting mechanism.

6. The method according to claim 4, wherein a relative distance between the work place and the location of the worker is computed from a longitude and latitude of the worker and the longitude and latitude of the work place.

7. The method according to claim 2, wherein at a time a terminal possessed by the worker receives the work request information, information on a type of a machine to be a work target is displayed on the terminal.

8. A method of using a computer system to assist a worker who takes charge of a predetermined work area and travels to and works at a work place by providing the worker with information of a work item outside the work area, the method comprising the steps of:
storing in a memory device work reception information which is information on an accepted work request from a client and which includes work request information that is needed when fulfilling the accepted work request;
extracting work reception information outside the work area of the worker and in an unaccepted state from the work reception information stored in the memory device;
extracting work reception information showing that a work target is a type of a machine assigned to the worker from the extracted work reception information;
extracting work request information included in the extracted work reception information and sending that work request information to a terminal possessed by the worker; and
updating the work reception information corresponding to the selected work request information to an accepted state from an unaccepted state when the reception information sent to the terminal is selected by the worker.

9. The method according to claim 8, wherein that work reception information which indicates that the work target of the worker is a machine type assigned to the worker is extracted from the extracted work reception information by comparing information on a machine type included in the work reception information with information on the machine type assigned to the worker stored in a worker information memory section.

10. A method of using a computer system to assist a worker who takes charge of a predetermined work area and travels to and works at a work place by providing the worker with information of a work item outside the work area, the method comprising the steps of:
storing in a memory device work reception information which is information on an accepted work request from a client and which includes work request information that is needed when fulfilling the accepted work request;
extracting work reception information outside the work area of the worker and in an unaccepted state from the work reception information stored in the memory device;
extracting work reception information showing that a required skill for a work item is equal to or less than a skill of the worker from the extracted work reception information;
extracting work request information included in the extracted work reception information and sending that work request information to a terminal possessed by the worker; and
updating the work reception information corresponding to the selected work request information to an accepted state from an unaccepted state when the reception information sent to the terminal is selected by the worker.

11. The method according to claim 10, wherein it is determined whether or not the required skill for the work is equal to or less than the skill of the worker by comparing the required skill stored in the work reception information with the skill of the worker stored in a worker information memory section.

12. A method of using a computer system to assist a worker who takes charge of a predetermined work area and travels to and works at a work place by providing the worker with information of a work item outside the work area, the method comprising the steps of:
storing in a memory device work reception information which is information on an accepted work request from a client and which includes information about a work place indicating a place of the accepted work request and work request information that is needed when fulfilling the accepted work request;
extracting work reception information outside the work area of the worker and in an unaccepted state from the work reception information stored in the memory device;
computing a travel time from a location of the worker to the work place;
extracting work reception information showing that the travel time lies within a predetermined time from the extracted work reception information;
extracting work request information included in the extracted work reception information and sending that work request information to a terminal possessed by the worker; and
updating the work reception information corresponding to the selected work reception information to an accepted state from an unaccepted state when the work request information sent to the terminal is selected by the worker.

13. The method according to claim 12, wherein the travel time from the location of the worker to the work place is computed by using a longitude and latitude of the worker, detected by a position detecting mechanism, and a longitude and latitude of the work place.

14. The method according to claim 2, wherein a map screen showing the work place and the location of the worker is output to a display section of a terminal used by a supervisor who gives an instruction to the worker.

15. The method according to claim 2, further including the step of sending information about work reception information on a work which cannot be handled in one area or work request information in that work reception information to a worker in another area from a display section of a terminal used by a supervisor in the case where such work reception information exists.

16. The method according to claim 2, wherein the terminal possessed by the worker can display work reception information or work request information area-by-area.

17. The method according to claim 2, wherein the terminal possessed by the worker can display a map screen showing the work place and the location of the worker.

18. The method according to claim 2, wherein the work reception information is updated by progress update information sent from the terminal possessed by the worker.

19. The method according to claim 2, wherein at a time the terminal possessed by the worker receives the work request information, information about a degree of difficulty of a work item is displayed on the terminal.

20. The method according to claim 2, wherein the work reception information further includes a progress identifier indicating a progress state for a work item and it is determined based on presence or absence of the progress identifier of whether or not the work reception information has not been accepted yet.

21. The method according to claim 2, wherein a worker identifier is stored in the work reception information at a time when a work item is accepted and it is determined based on presence or absence of the worker identifier whether or not the work reception information has not been accepted yet.

22. The method according to claim 2, wherein the terminal possessed by the worker displays information about a procedure for the work item.

23. The method according to claim 2, wherein the work reception information includes information on a work day designating a day for doing a work and at a time when an unaccepted work item is extracted from the work reception information, the unaccepted work item is extracted from that work reception information which includes information on a work day corresponding to a designated date.

24. The method according to claim 2, wherein at a time the work reception information is updated to be in an accepted state, an identifier of the worker is stored in the unaccepted work reception information.

25. The method according to claim 2, wherein at a time the work reception information is updated to be in an accepted state, a progress identifier indicating a progress state of a work item is updated.

26. A computer recording medium on which computer program instructions are recorded for assisting a worker who takes charge of a predetermined work category by providing the worker with information of a work item outside the work category, wherein the computer program instructions are executed by a computer system, the computer system including at least a first memory device for storing reception information on goods or service request and a second memory device for storing worker information on the worker, wherein the computer program instructions when executed performing steps comprising:
extracting reception information about a request outside the work category of the worker and in an unaccepted state from the reception information stored in the first memory device based on the worker information;
extracting reception information about a request which can be handled by the worker from the reception information based on a predetermined condition;
transmitting the reception information extracted based on the predetermined condition to a terminal possessed by the worker; and
updating the selected reception information to an accepted state from an unaccepted state upon reception of notification that the reception information sent to the terminal has been selected by the worker.

27. A computer recording medium on which computer program instructions are recorded for assisting a worker who takes charge of a predetermined work category and travels to and works at a work place by providing the worker with information of a work item outside the work area, wherein the computer program instructions are executed by a computer system, the instructions when executed by the computer system performing steps comprising:
storing in a memory device work reception information which is information on an accepted work request from a client and which includes information about a work place indicating a place of the accepted work request and work request information that is needed when fulfilling the accepted work request;
extracting work reception information outside the work area of the worker and in an unaccepted state from the work reception information stored in the memory device;
computing a relative distance between the work place included in the extracted work reception information and the location of the worker;
extracting work reception information showing that the relative distance lies within a predetermined distance from the extracted work reception information;
extracting work request information included in the extracted work reception information and transmitting that work request information to a terminal possessed by the worker; and
updating the work reception information corresponding to the selected work request information to an accepted state from an unaccepted state when the reception information sent to the terminal is selected by the worker.

28. A computer recording medium on which computer program instructions are recorded for assisting a worker who takes charge of a predetermined work area and travels to and works at a work place by providing the worker with information of a work item outside the work area, wherein the computer program instructions are executed by a computer system, the instructions when executed by the computer system performing steps comprising:
storing in a memory device work reception information which is information on an accepted work request from a client and which includes information about a work place indicating a place of the accepted work request and work request information that is needed when fulfilling the accepted work request;
extracting work reception information outside the work area of the worker and in an unaccepted state from the work reception information stored in the memory device;
extracting information showing that a work target is a type of a machine assigned to the worker from the extracted work reception information;
extracting work request information included in the extracted work reception information and transmitting that work request information to a terminal possessed by the worker; and
updating the work reception information corresponding to the selected work request information to an accepted state from an unaccepted state when the reception information sent to the terminal is selected by the worker.

29. A computer recording medium on which computer program instructions for assisting a worker who takes charge of a predetermined work area and travels to and works at a work place by providing the worker with information of a work outside the work category is recorded, wherein the computer program instructions are executed by a computer system, the instructions when executed by the computer system performing steps comprising:
storing in a memory device work reception information which is information on an accepted work request from a client and which includes information about a work place indicating a place of the accepted work request and work request information that is needed when fulfilling the accepted work request;
extracting work reception information outside the work area of the worker and in an unaccepted state from the work reception information stored in the memory device;
extracting work reception information showing that a required skill for a work item is equal to or less than a skill of the worker from the extracted work reception information;
extracting work request information included in the extracted work reception information and transmitting that work request information to a terminal possessed by the worker; and
updating the work reception information corresponding to the selected work request information to an accepted state from an unaccepted state when the reception information sent to the terminal is selected by the worker.

30. A computer recording medium on which computer program instructions are recorded for assisting a worker who takes charge of a predetermined work area and travels to and works at a work place by providing the worker with information of a work item outside the work area, wherein the computer program instructions are executed by a computer system, the instructions when executed by the computer system performing steps comprising:
storing in a memory device work reception information which is information on an accepted work request from a client and which includes information about a work place indicating a place of the accepted work request and work request information that is needed when fulfilling the accepted work request;
extracting work reception information outside the work area of the worker and in an unaccepted state from the work reception information stored in the memory device;
computing a travel time from a location of the worker to the work place;
extracting work reception information showing that the travel time lies within a predetermined time from the extracted work reception information;
extracting work request information included in the extracted work reception information and transmitting that work request information to a terminal possessed by the worker; and
updating the work reception information corresponding to the selected work request information to an accepted state from an unaccepted state when the reception information sent to the terminal is selected by the worker.
